(19) United States
(12) Patent Application Publication
(10) Pub. No.: US 2016/0249233 A1
(43) Pub. Date: Aug. 25, 2016

(54) PROVIDING BROADBAND SERVICE TO TRAINS

(71) Applicant: VODAFONE IP LICENSING LIMITED, Newbury, Berkshire (GB)

(72) Inventors: Eric MURRAY, Newbury, Berkshire (GB); Robert BANKS, Newbury, Berkshire (GB); Ian NEWTON, Newbury, Berkshire (GB); Peter LONGDEN, Newbury, Berkshire (GB); Philip WHITE, Newbury, Berkshire (GB); Ralf IRMER, Newbury, Berkshire (GB)

(21) Appl. No.: 15/031,565

(22) PCT Filed: Oct. 24, 2014
(86) PCT No.: PCT/GB2014/053182

§ 371 Date: Apr. 22, 2016

(30) Foreign Application Priority Data
Oct. 24, 2013 (GB) 1318822.2
Nov. 22, 2013 (GB) 1320672.7
May 12, 2014 (GB) 14084404.0

(51) Int. Cl. H04W 24/02; B61K 13/00; H04W 16/26; H04B 7/04; H04L 29/08

(52) U.S. Cl. CPC H04W 24/02; H04B 7/0413; H04L 67/12; H04W 16/26; B61K 13/00; H04W 84/005

(57) ABSTRACT

A cellular radio network system and method for communicating with at least one vehicle-based mobile gateway terminal is provided. The at least one mobile gateway terminal is configured to communicate a network service for one or more user mobile terminals on-board the vehicle. A plurality of network cells provide cellular radio network coverage along a route of the vehicle. Each network cell is dedicated for communication with the at least one vehicle-based mobile gateway terminal so as to allow communication between the at least one vehicle-based mobile gateway terminal and a core network of the cellular radio network.

### BACKGROUND TO THE INVENTION

Smartphones, tablets and laptops are now essential devices in developed economies, and many rail passengers carry at least one of these devices with them during their journey. As Wi-Fi support is nearly ubiquitous on such devices, and 3G or 4G mobile broadband support also common (either built into devices or via an inexpensive dongle), many of these passengers would like to be able to use their devices for activities such as work, entertainment or travel information. People have a natural expectation that their devices should work as well on a train as anywhere else, but this is rarely the case. The use of metallised film windows in railway carriages for the purposes of climate control limits direct coverage by cellular networks, as these have a high penetration loss at microwave frequencies. Furthermore, cellular networks are usually not optimised for railway coverage, resulting in a very variable service. Hence quality by direct coverage is generally poor, with voice calls unable to be maintained for long periods and mobile internet only available in urban areas and with a lower than average speed.

Several train operating companies (TOCs) have responded to these problems by installing Wi-Fi access points in each carriage, with the backhaul usually being provided either by an aggregation of available 3G connections from the existing cellular operators, or by satellite. This solves the problem of the high carriage penetration loss and gives a more consistent service. However, backhaul rates are still typically limited to a few Mb/s which must be shared amongst an increasing number of users, whose individual demands are also rising. More recently, some TOCs and, indeed, governments have foreseen for a need for free Wi-Fi. To achieve this, ubiquitous coverage both within the train itself and along the whole route is required, along with sufficient capacity to support both the reasonable demands of all passengers and the rail industry itself. This is not a trivial problem, however, as the density of mobile devices in a train is amongst the highest possible. For example, an ICE train in Germany has 750 seats and can carry up to 1500 people.

### Data Requirements

Applications used on trains may include both safety critical applications (currently provided between train and shore using GSM-R) and non-critical applications designed to improve either the efficiency of railway operations (e.g. yield management) or passenger experience (e.g. passenger information).

These applications can be split into two categories:
On Train, where the source or destination of the traffic is on-board a train. For these applications, a mobile solution is required. If some of the applications have a high data rate requirement, then a mobile broadband solution is required.
On Shore, where both the source and destination of the traffic are in a fixed location, at least one of which is located within the railway boundaries. For these applications, fixed networks can be used. However, mobile solutions may offer some advantages in terms of reduced installation costs or increased reliability (by, for example, eliminating the cable theft risk).

“On Train” applications may include passenger applications (e.g, High Speed internet access, Passenger information (LCD LED), Passenger entertainment (audio, video, live TV), Passenger voice calls) and railway applications (e.g., railway system condition monitoring, CCTV low-resolution train to shore, CCTV high-resolution train to shore real time, Traffic management, ATO and driverless trains, Intelligent monitoring, Yield management, Capacity driven by market demand in real-time, Multi-purpose core routes, Control of train operations—Data, Ticketing and revenue collection, Delay attribution, Provision of on board catering/retailing, Control of train operations—Voice). The on-train data rate requirement to support these applications may therefore be quite large, probably in the range of tens of MB/s. For example, up to 10 Mb/s, up to 30-35 Mb/s, up to 50 Mb/s, up to 60 Mb/s, even up to 70-80 Mb/s.

On the other hand, “On shore” applications include CCTV to voice communications to railway operations and monitoring. Many of these applications are safety critical, and perhaps best served using fixed infrastructure. The exception is mobile voice communications, where public mobile networks may be used. Some of these “on shore” applications may migrate to a mobile broadband network in areas where, for example, cable theft is a problem or the provision of fixed infrastructure expensive.

### Current Solutions

Solutions to provide data coverage to trains have evolved along with improving technology and increasing user expectations. A history of evolving solutions is given below.

### (a) Direct Coverage

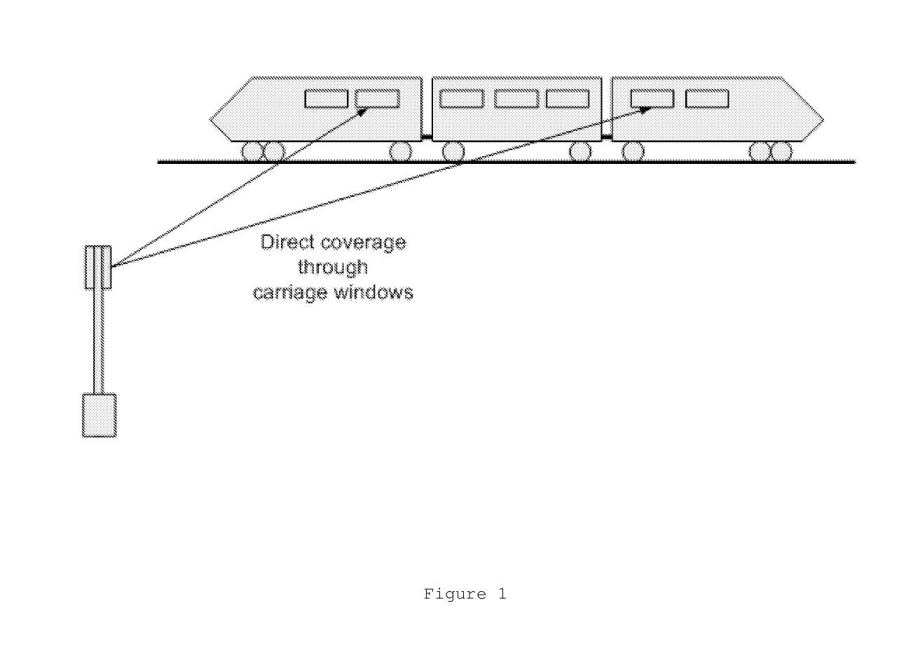

Direct coverage (as shown in FIG. 1) is the method by which most cellular users receive coverage—directly from the macro sites to the terminal. This was the original method used when no special measures were taken to provide a service to rail passengers. It has the great advantage that it is cheap—no additional infrastructure is required on the trains. However, there are a number of important disadvantages.

First, cellular coverage is generally not optimised for rail coverage. Second, the introduction of metallised-film windows for climate control on the majority of railway carriages has significantly increased radio attenuation for direct coverage. Finally, coverage does not guarantee capacity, as the macro network serves all cellular customers, not just railway passengers. Hence, even when adequate coverage is available by direct propagation, the capacity available cannot be guaranteed as this is shared with other users of the network. Hence adequate coverage does not guarantee an adequate service. This is especially true in urban areas where railway stations are usually located in densely populated town centres.

### (b) On-Train Repeaters

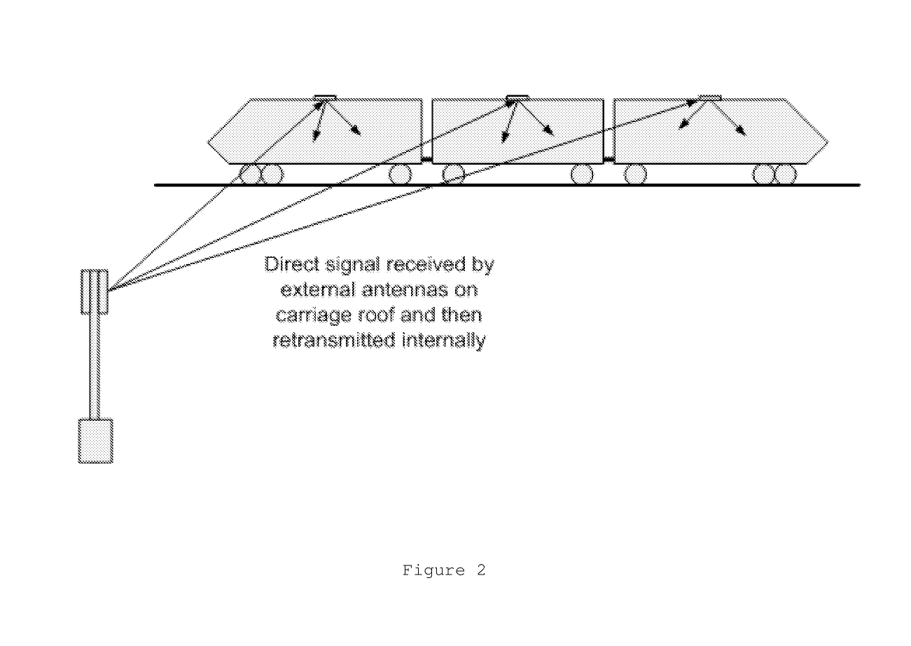

The solution to the carriage attenuation problem was to install on-train cellular repeaters (as shown in FIG. 2), whereby an external antenna was placed on the roof of the train to receive the signal from the macrocell, which was then re-transmitted by separate antennas located in the carriage.

Although this solves the carriage attenuation problem, it does not solve the problems of inadequate macrocell density or capacity. In addition, either a multi-band repeater or a separate repeater is required for each MNO, which increases costs. Where used, MNOs will typically only install GSM repeaters (primarily to provide a better voice service, though they will also improve GPRS coverage), though some operators have started to install UMTS repeaters.

### (c) Satellite Coverage

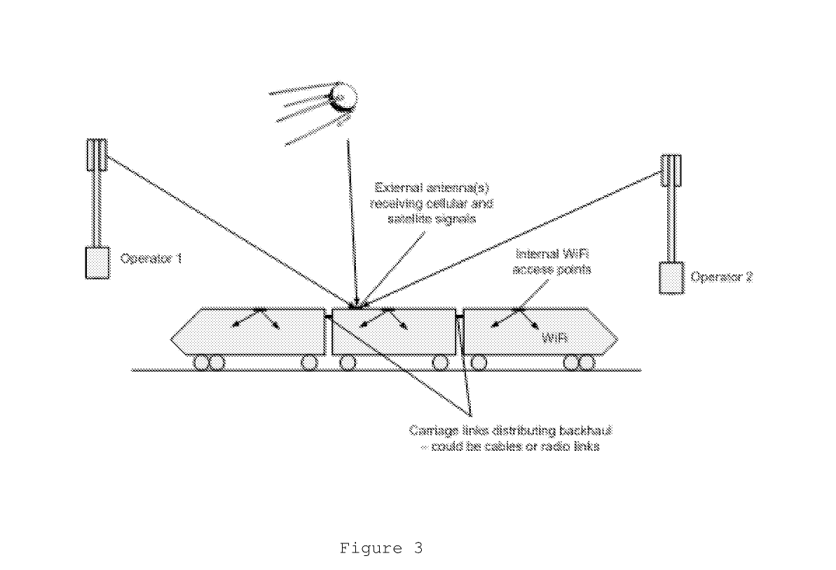

Some TOCs have solved the coverage problem by using satellite broadband services (as shown in FIG. 3). These provide near ubiquitous coverage (tunnels and deep cuttings excepted), but are limited in capacity to around 2 Mb/s per train. This capacity is usually used to provide a Wi-Fi rather than a cellular service.

### (d) Dedicated Terrestrial Solutions

Carrier aggregation may increase capacity compared to using a single operator, but coverage by different MNOs is usually reasonably correlated (particularly if site sharing), and hence this approach does not solve the problem of limited coverage. In addition, the capacity available is still much lower than the requirement identified above. For these reasons, there has been a trend towards dedicated trackside coverage solutions for railways.

Initial dedicated solutions have tended to use IEEE 802 standards, such as the use of WiMAX or Wi-Fi (a problem with these is that their spectra are subject to low transmit power limits and can suffer from interference), other solutions use proprietary OFDM-based solutions tailored to the requirements of the rail industry.

### SUMMARY OF THE INVENTION

Against this background, there is provided a cellular radio network system for communicating with a vehicle-based mobile terminal, especially a train. This may be provided in combination with a vehicle-based mobile terminal or alone. There is further provided a cellular radio network system for communicating with at least one vehicle-based mobile gateway terminal, the at least one mobile gateway terminal being configured to communicate (and particularly thereby provide) a network service for one or more user mobile terminals on-board the vehicle. Preferably, the system comprises a plurality of network cells, configured to provide cellular radio network coverage along a route of the vehicle. Each network cell is dedicated for communication with the at least one vehicle-based mobile gateway terminal so as to allow communication between the at least one vehicle-based mobile gateway terminal and a core network of the cellular radio network.

In other words, the cellular radio network system provides cells that are dedicated to providing backhaul service to the mobile terminal gateway on-board the vehicle. This backhaul is itself provided using cellular network communication and allows the mobile terminal gateway to provide voice and/or data services to on-board user mobile terminals (which may be User Equipment or UE, or other networking devices, for example using Wireless LAN). The cells may be considered dedicated in the sense that traffic from vehicle-based mobile terminal gateway or gateways is (mostly or always) prioritised higher than other traffic or that only that traffic from vehicle-based mobile terminal gateway is (mostly or always) permitted through these cells. The dedicated nature of the cells may also be embodied in the use of directional antennas, as will be discussed below. Such cells may be provided in addition to other, regular cells of the cellular radio network. The term mobile gateway terminal is used, as it may act as a gateway between the one or more user mobile terminals on-board the vehicle and the core network, to allow a service to be provided. As noted above, the vehicle may be a train. The network service may be a cellular radio network service or another type of communications service, as will be discussed below.

In the preferred embodiment, the vehicle route is predetermined and the plurality of network cells are located along the predetermined route. A spatial separation between at least one of the plurality of network cells and the predetermined route (such as a train track) is optionally based on one or more of: the height of an antenna of the cell; a height of the vehicle; a maximum, minimum or average distance between the vehicle and the antenna; and the frequency of communication. In particular, the spacing, distance or both may be selected such that a Fresnel zone (or at least a first Fresnel zone) clears the ground (or another obstacle) when the on-board mobile gateway terminal is in communication with the respective cell.

The system may comprise a plurality of masts, each mast having at least one antenna structure or construction mounted thereupon. Each antenna structure or construction may be coupled to a respective, separate cell for communication with the vehicle-based mobile terminal, although in some embodiments, multiple antenna structures or constructions on the same mast may be coupled to the same cell. The cells may be connected to each other, to a network backhaul or both using an optical fibre system.

The masts may be spatially separated from one another, for example at regular intervals. They are typically located along a dedicated or predetermined route of the vehicle-based mobile terminal, such as a train track. This spatial separation may be selected on the basis of cellular radio network coverage. The distance between each mast and a dedicated route of the vehicle-based mobile terminal, such as a track may be based on one or more of: the height of the antenna on the mast; the height of the mast; the height of the vehicle; the maximum, minimum or average distance between the vehicle and the mast (or a combination of these values); and the frequency of communication. As noted above, the spacing, distance or both may be selected such that a Fresnel zone (or at least a first Fresnel zone) clears the ground (or another obstacle) when the vehicle is in communication with the antenna on the mast.

In the preferred embodiment, each network cell is configured to allow the at least one mobile gateway terminal to provide network service for the one or more user mobile terminals on-board the vehicle to be one or more of: a circuit-switched cellular radio network service (such as voice or Short Messaging Service, SMS); a packet-switched cellular radio network service (such as Voice over LTE, VoLTE); and a packet-switched non-cellular radio network service (for example, Wireless LAN services, including Voice over IP provided via a Wireless LAN). This network service m to the one or more user mobile terminals on-board the vehicle. A voice service may be provided alone, but is typically provided in addition to a data service, although a data service alone may optionally be provided. The provision of circuit-switched traffic may advantageously be possible by the use of a cellular radio network backhaul, for example for 3G services. A network cell, Wireless LAN Access Point or other device in communication with or part of the mobile gateway terminal may directly provide the network service to the user mobile terminals on-board the vehicle.

As noted previously, each of the plurality of network cells may have at least one respective antenna. Then, the at least one antenna of a first of the plurality of network cells being co-located with the at least one antenna of a second of the plurality of network cells. In other words, the antenna or antennas of one cell may be co-sited (such as on the same mast) as the antenna or antennas of another cell. The other parts of the cell equipment for both cells may also be co-located or co-sited.

Beneficially, each of the plurality of network cells has a respective MIMO antenna structure. Alternatively or additionally, each of the plurality of network cells may have a respective directional antenna structure. Directional antennas are advantageous in assisting in the dedicated nature of the cells. Each directional antenna structure optionally preferably has a beam width not greater than 30° or 33° (although in some embodiments, the beam width may be 35°, 40°, 50° or 60°). Each of the MIMO antenna structures may be cross-polarised (that is comprise cross-polarised antennas). Each mast may have a plurality of MIMO antenna structures mounted thereupon. The plurality of MIMO antenna structures may be spatially separated from one another. This spatial separation may be horizontal (with respect to the ground) or vertical or a combination of the two. The spatial separation may be at least, approximately or at 10A (wherein A is the wavelength of the transmission frequency).

Optionally, each network cell is configured for communication with the at least one vehicle-based mobile gateway terminal using a Long Term Evolution (LTE) architecture. This may be useful in allowing a high data rate service to be provided over this dedicated backhaul link, which may be sufficient to provide service to multiple on-board mobile terminals.

Advantageously, each network cell is configured to allow communication between a network cell on-board the vehicle that is in communication with the at least one vehicle-based mobile gateway terminal and a core network of the cellular radio network using an Iub over IP protocol. The network cell may be a 3G network cell and optionally a small cell, such as a femto cell or pico cell.

In embodiments, the at least one mobile gateway terminal is configured to act or be in communication with another device that is configured to act, in order to provide the cellular radio network service to one or more user mobile terminals on-board the vehicle, as one or more of: a cellular radio network repeater; a local access point for the cellular radio network; a gateway to a Local Area Network; and a network cell (particularly a small cell, such as a femto-cell). This may further assist is provided a seamless service to one or more user mobile terminals on-board the vehicle, communicating through the mobile gateway terminal.

In another aspect, there may be provided a method for communicating with at least one vehicle-based mobile gateway terminal, so as to allow the at least one mobile gateway terminal to provide a cellular radio network service to one or more user mobile terminals on-board the vehicle. The method comprises: providing cellular radio network coverage along a route of the vehicle using a plurality of network cells, each network cell being dedicated for communication with the at least one vehicle-based mobile gateway terminal; and configuring the plurality of network cells to allow communication between the at least one vehicle-based mobile gateway terminal and a core network of the cellular radio network. This method may optionally have process features corresponding with any of the structural features described herein.

In further aspects, there is provided a vehicle-based mobile terminal of a cellular radio network, preferably for use on a train. The mobile terminal may comprise an antenna system at either end of the vehicle. Each antenna system may comprise at least one antenna, with two or more being provided to support MIMO capable modems (e.g., a MIMO antenna).

The mobile terminal may be for Third Generation Partnership Project (3GPP) Long Term Evolution (LTE) operation. This can have advantages in providing a high throughput and supports difficult radio propagation environments with Doppler shift. Each base station may be an eNodeB. Either Frequency Division Duplex (FDD) LTE or Time Division Duplex (TDD) LTE can be used (or any similar system and/or combination of systems). Advantageously, Time Division Duplex (TDD) LTE is used. This may be further beneficial in allowing asymmetric uplink and downlink. This may be advantageous for vehicle-based operation, which tends to use downlink more than uplink. Alternatively, the mobile terminal may be for a 3G based operation (e.g., UMTS, WCDMA, etc.) and each base station may be a NodeB. Alternatively, the mobile terminal may be for newer releases of a 3GPP or IEEE standard (e.g., LTE-Advanced, WiMAX, 5G, etc.). If suitable, other cellular communication operations could be supported by the mobile terminal (e.g., GSM, EDGE, DCS, CDMA, WCDMA). Alternatively, the mobile terminal may be operable to work with two or more of the various cellular communication systems mentioned above.

Each antenna system may be connected to a respective, separate modem. This may allow each modem to communicate with (or connect to) a different cell of the cellular radio network. One or more of the antennas may use carrier aggregation to communicate with a plurality of base stations of the cellular radio network. Each modem may be for the same Radio Access technology (RAT) operation (e.g., LTE, 3G, GSM, EDGE, DCS, CDMA, WCDMA, LTE-Advanced, WiMAX, 5G, etc.) or for different RATs operations (e.g., one modem for LTE, one for 3G, etc.). In the latter case, some sort of carrier aggregation and/or connection aggregation and/or session aggregation (or similar types of aggregations) could be used.

The antenna system at each end of the vehicle may comprise a plurality of antennas. Each antenna system is preferably mounted externally on the vehicle. Each of the plurality of antennas may be singularly polarised. In particular, two antennas may be used to support 2×2 MIMO. Four antennas may be used to support 4×4 MIMO. The four antennas may be configured in a square or in another construction, in which antennas are grouped. For example, orthogonally-polarised antennas may be grouped together in a single construction. Moreover, the plurality of antennas are preferably spatially separated, with a preferred separation of 10λ (wherein λ is the wavelength of the transmission frequency) or at least 10λ in some embodiments. Additionally or alternatively, some of the plurality of antennas may be tilted. For example, half of the plurality of antennas may be tilted in one direction and half may be tilted in another direction. The degree of tilt may be 45°. In some embodiments, two antennas may be tilted by 45° in one direction and two antennas may be tilted by 45° in the other direction. This may be used to provide polarisation diversity.

The vehicle-based mobile terminal may act as one or more of: a cellular radio network repeater; a local access point for the cellular radio network; a gateway to a Local Area Network (LAN, such as a wireless LAN); or a network cell. This is preferably provided for other mobile terminals located on-board the vehicle. For example, it may provide femto-cell, pico-cell or other small cell coverage for other mobile terminals located on-board the vehicle. When the vehicle-based mobile terminal acts to provide coverage for other mobile terminals located on-board the vehicle, the vehicle-based mobile terminal may connect to a core of the cellular radio network via a wireless communication link which operates according to a specific interface, such as LTE (TDD or FDD), 3G, etc.—e.g. an LTE wireless communication link. The wireless communication link may be with a macro node of the cellular radio network and/or with a dedicated node along the vehicle route. The macro node and/or the dedicated node are connected to the core of the cellular radio network (e.g., via a wired link). Hence, the vehicle-based mobile terminal effectively “extends” the coverage of the cellular radio network to on-board the vehicle by allowing other mobile terminals on-board the vehicle to directly connect to the core of the cellular radio network in a reliable way and with an improved coverage. In other words, the vehicle-based mobile terminal provides a connection to the cellular radio network for the one or more of the other mobile terminals on-board the vehicle. The one or more of the other mobile terminals on-board the vehicle are capable of connecting to the vehicle-based mobile terminal using one or more interfaces (e.g., one or more cellular interfaces such as LTE, 3G, etc., and/or one or more non-cellular interfaces such as Wi-Fi, etc.) to perform voice and/or data communications with the cellular radio network to which the vehicle-based mobile terminal connects. The interface used by the one or more of other mobile terminals on-board the vehicle to communicate with the vehicle-based mobile terminal may be the same or a different one than that used by the vehicle-based mobile terminal to communicate with the cellular radio network. Hence, the vehicle-based mobile terminal may be configured to support multiple access interfaces (e.g., LTE, 3G, Wi-Fi, etc.) over the communication link with the one or more of the other mobile terminals on-board the vehicle and manage data and/or voice flows between the wireless communication link with the cellular radio network and (i) the multiple access interfaces supported over the communication link with the one or more of the other mobile terminals on-board the vehicle and/or (ii) the one or more of the other mobile terminals on-board the vehicle.

The solution as described would greatly improve the communication capabilities of the other mobile terminals on-board the vehicle, as well as simplifying the procedures that allow the other mobile terminals on-board the vehicle to remain connected with the cellular radio network. For example, each of the mobile terminals to which the vehicle-based mobile terminal provides coverage could be connected to macro nodes of the cellular radio network directly. However, by having the mobile terminals connected to the cellular radio network via the vehicle-based mobile terminal, the mobile terminals does not need to implement procedures for managing its connection with macro nodes of the cellular radio network (e.g., handover procedures, power control, etc.). By having the vehicle-based mobile terminal connected to the cellular radio network, only the vehicle-based mobile terminal would need to implement these procedures to remain connected with the cellular radio network. For the mobile terminals on-board the vehicle, the connection to be managed is that with the vehicle-based mobile terminal, which from the point of view of the mobile terminals may be seen as a “fixed” access point. This is turn improves the lifetime of the mobile terminals on board the vehicle (e.g., less battery will be used), simplifies the operations at the mobile terminals, and optimises the operation for the overall cellular radio network as only one connection (with all the relevant procedure and parameters to be managed), namely that with the vehicle-based mobile terminal, is needed to serve a large number of mobile terminals on board of the vehicle.

Handover techniques may be provided to prevent mobile terminals on board the vehicle from attaching to cells on the same cellular communications network other than the small cell provided on-board the vehicle. For example, a limited physical cell identifier may be implemented, neighbouring lists may be set appropriately and special system parameters may be applied, such as hysteresis time-to-trigger. Restricted initial analysis may be provided and a hysteresis-offset may be applied to the handover between the small cell on-board the vehicle and the on-board mobile terminals.

The frequency of communication between the mobile terminal of the vehicle and the system (that is, the cellular radio network) may be selected to be at least 2 GHz, 2.6 GHz, 3 GHz or 3.5 GHz. A high frequency may be advantageous where line of sight propagation is to be implemented. This may avoid the ground and other obstacles disrupting radio propagation between the vehicle-based mobile terminal and the mast-mounted antenna constructions. Hence, this frequency may be applicable to the vehicle-based mobile terminal, the cellular radio network system, both or a combination of the two.

Any methods may be implemented as programmable or dedicated logic, computer software or firmware or a combination thereof. The combination of any specific apparatus or method features described herein is also provided, even if that combination of features is not explicitly detailed.

### DETAILED DESCRIPTION OF A PREFERRED EMBODIMENT

### Backhaul

A dedicated terrestrial infrastructure located along the railway tracks is the described solution to achieve the required high data throughput. As discussed above, current dedicated solutions are not adequate to provide the required high data throughput.

Accordingly, the proposed dedicated terrestrial infrastructure will comprise number of improvements, some of which are described here.

### (i) Backhaul Technology

The backhaul technology will be improved by using LTE as the backhaul (for example, from the train to the shore and vice versa) communications technology. The use of LTE as the backhaul has many advantages, for example:
LTE is designed for high throughput mobile broadband connections, with features such as high bandwidth, MIMO and adaptive modulation and coding.
LTE is designed for mobile applications with reliable support for related features such as seamless handover, tolerance of high user Doppler shifts and interference management.
LTE is subject to standardisation, thus potentially allowing future improving features.
LTE equipment is available for many spectrum bands
The TDD variant of LTE, TD-LTE, has the advantage that the resource split between the uplink and downlink can be easily changed. Hence optimal use can be made of the available spectrum according to the experienced demand.

In addition, backhaul from the trackside sites themselves can be provided by the fibre optic cables.

The peak data rates that may be supported by LTE are detailed below. The number of configurations for TDD is higher because of: (i) the possible uplink/downlink resource splits; and (ii) the number of possible configurations for the special subframe.

### FDD

For FDD, here is the peak throughput available:

| Peak | Bandwidth | |
|---|---|---|
| Throughput | 2 × 10 MHz | 2 × 20 MHz |

| (Mb/s) | Uplink | Downlink | Uplink | Downlink |
|---|---|---|---|---|
| 2 Streams | 75.4 | 75.4 | 149.7 | 149.7 |
| 4 Streams | 146.9 | 146.9 | 299.9 | 299.9 |

Note that the uplink and downlink throughputs may be symmetric if this is enforced by the duplex method. Additionally, note that 4 stream MIMO may require high spatial separation between the antennas to achieve the required de-correlation.

### TDD

The preferred configurations are Special SubFrame Configuration 4 and/or SubFrame Configurations 3, 4 or 5.

| | | | Peak Throughput (Mb/s) | | | | | | |
|---|---|---|---|---|---|---|---|---|---|
| Special | | | 20 MHz Bandwidth | | | | | | |
| SubFrame | | UL/ | SubFrame Configuration | | | | | | |
| Configuration | | DL | 0 | 1 | 2 | 3 | 4 | 5 | 6 |
| 2 Streams | 0 | UL | 92.0 | 62.1 | 32.1 | 46.0 | 31.0 | 16.0 | 77.0 |
| | | DL | 29.9 | 59.9 | 89.9 | 89.9 | 104.8 | 119.8 | 44.9 |
| | 1 | UL | 92.0 | 62.1 | 32.1 | 46.0 | 31.0 | 16.0 | 77.0 |
| | | DL | 49.2 | 79.2 | 109.1 | 99.5 | 114.5 | 129.4 | 64.2 |
| | 2 | UL | 92.0 | 62.1 | 32.1 | 46.0 | 31.0 | 16.0 | 77.0 |
| | | DL | 51.4 | 81.3 | 111.3 | 100.6 | 115.5 | 130.5 | 66.3 |
| | 3 | UL | 92.0 | 62.1 | 32.1 | 46.0 | 31.0 | 16.0 | 77.0 |
| | | DL | 53.5 | 83.4 | 113.4 | 101.6 | 116.6 | 131.6 | 68.5 |
| | 4 | UL | 92.0 | 62.1 | 32.1 | 46.0 | 31.0 | 16.0 | 77.0 |
| | | DL | 55.6 | 85.6 | 115.5 | 102.7 | 117.7 | 132.7 | 70.6 |
| | 5 | UL | 94.1 | 64.2 | 34.2 | 47.1 | 32.1 | 17.1 | 79.2 |
| | | DL | 29.9 | 59.9 | 89.9 | 89.9 | 104.8 | 119.8 | 44.9 |
| | 6 | UL | 94.1 | 64.2 | 34.2 | 47.1 | 32.1 | 17.1 | 79.2 |
| | | DL | 49.2 | 79.2 | 109.1 | 99.5 | 114.5 | 129.4 | 64.2 |
| | 7 | UL | 94.1 | 64.2 | 34.2 | 47.1 | 32.1 | 17.1 | 79.2 |
| | | DL | 51.4 | 81.3 | 111.3 | 100.6 | 115.5 | 130.5 | 66.3 |
| | 8 | UL | 94.1 | 64.2 | 34.2 | 47.1 | 32.1 | 17.1 | 79.2 |
| | | DL | 53.5 | 83.4 | 113.4 | 101.6 | 116.6 | 131.6 | 68.5 |
| | 9 | UL | 94.1 | 64.2 | 34.2 | 47.1 | 32.1 | 17.1 | 79.2 |
| | | DL | 42.8 | 72.7 | 102.7 | 96.3 | 111.3 | 126.2 | 57.8 |
| 4 Streams | 0 | UL | 184.2 | 124.2 | 64.3 | 92.1 | 62.1 | 32.1 | 154.2 |
| | | DL | 60.0 | 120.0 | 179.9 | 179.9 | 209.9 | 239.9 | 89.9 |
| | 1 | UL | 184.2 | 124.2 | 64.3 | 92.1 | 62.1 | 32.1 | 154.2 |
| | | DL | 98.5 | 158.5 | 218.5 | 199.2 | 229.2 | 259.2 | 128.5 |
| | 2 | UL | 184.2 | 124.2 | 64.3 | 92.1 | 62.1 | 32.1 | 154.2 |
| | | DL | 102.8 | 162.8 | 222.8 | 201.3 | 231.3 | 261.3 | 132.8 |
| | 3 | UL | 184.2 | 124.2 | 64.3 | 92.1 | 62.1 | 32.1 | 154.2 |
| | | DL | 107.1 | 167.1 | 227.0 | 203.5 | 233.5 | 263.4 | 137.1 |
| | 4 | UL | 184.2 | 124.2 | 64.3 | 92.1 | 62.1 | 32.1 | 154.2 |
| | | DL | 111.4 | 171.3 | 231.3 | 205.6 | 235.6 | 265.6 | 141.4 |
| | 5 | UL | 188.5 | 128.5 | 68.5 | 94.2 | 64.3 | 34.3 | 158.5 |
| | | DL | 60.0 | 120.0 | 179.9 | 179.9 | 209.9 | 239.9 | 89.9 |
| | 6 | UL | 188.5 | 128.5 | 68.5 | 94.2 | 64.3 | 34.3 | 158.5 |
| | | DL | 98.5 | 158.5 | 218.5 | 199.2 | 229.2 | 259.2 | 128.5 |
| | 7 | UL | 188.5 | 128.5 | 68.5 | 94.2 | 64.3 | 34.3 | 158.5 |
| | | DL | 102.8 | 162.8 | 222.8 | 201.3 | 231.3 | 261.3 | 132.8 |
| | 8 | UL | 188.5 | 128.5 | 68.5 | 94.2 | 64.3 | 34.3 | 158.5 |
| | | DL | 107.1 | 167.1 | 227.0 | 203.5 | 233.5 | 263.4 | 137.1 |
| | 9 | UL | 188.5 | 128.5 | 68.5 | 94.2 | 64.3 | 34.3 | 158.5 |
| | | DL | 85.7 | 145.6 | 205.6 | 192.8 | 222.8 | 252.7 | 115.7 |

The configuration for TDD may be determined as a combination (e.g., based on both) of a special subframe configuration and a subframe configuration. The performance may also depend on the number of streams available (e.g., 2 streams or 4 streams), which in turn depends on the number of antennas at either end of the link (e.g., the maximum number available depends on the number of antennas available at both ends of the link). The system may automatically select the number of streams to use. For example, the preferred configuration may be the one that maximizes the downlink resources for a specific Guard Period (GP). The special subframe configuration primarily determines the size of the GP, which in turn may determine the maximum range of the cell. The minimum GP is 1 symbol, or 71 μs, which corresponds to a maximum cell range of 10.7 km. This may be more than enough for a network based on typical GSM-R site spacings, hence all of the above special subframe configurations may be used. A special subframe configuration which allows for higher downlink resources and/or for a higher ratio between downlink resources and uplink resources may be preferred.

It is noted that a “normal” subframe may be formed of either all uplink slots or all downlink slots. On the other hand, a special subframe is typically formed of some uplink slots, some downlink slots and a guard period. The special subframe configuration specifies the relative ratios between the normal subframe structure and the special subframe structure. There are 10 valid special subframe configurations which are specified by 3GPP.

The subframe configuration defines the split between uplink and downlink resources. Some subframe configuration (e.g., 0, 1, 2 and 6) allows for a 5 ms frame periodicity, and consequently defines two special subframes per frame. A subframe configuration having more resources in the downlink than in the uplink may be preferred. This preference is due to the expected traffic asymmetry (e.g., more traffic in one direction—downlink—than in the other direction—uplink). Also, a 10 ms periodicity may be preferred as this gives a higher throughput (both uplink and downlink) than a 5 ms periodicity. Hence, a configuration that allows a 10 ms periodicity (e.g., subframe configurations 3, 4 or 5) may be preferred—in turn, this defines one special subframe per frame.

Some configuration may have a ratio between the downlink resources and the uplink resources which is greater than 2, preferably about 3 or 4, and up to about 9. The specific subframe configuration used may depend on the required split between uplink and downlink resources.

### (ii) Carrier Aggregation

The capacity available from two or more operators can be combined (“aggregated”) in a train-mounted gateway, which is then used to feed Wi-Fi access points located throughout the train. Wi-Fi access points could also combine satellite capacity.

(iii) Spectrum

LTE is licensed to operate in several bands within Europe, ranging from 800 MHz (Band 8) up to 3600-3800 MHz (Band 43). They can all be applied as appropriate. In general, more spectrum is available in the higher bands, which would increase throughputs. However, the range of a cell tends to decrease as the frequency increases.

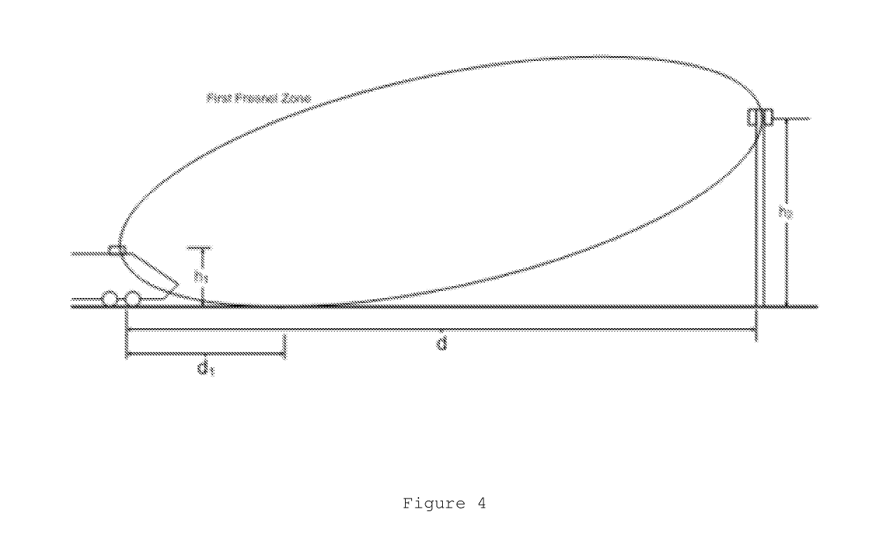

In the preferred embodiment, a spectrum in the high frequencies (e.g., 2.6 GHz band) is proposed to be used to provide a train backhaul service using LTE. This is because the benefits of lower frequencies, in terms of increased range and lower site counts, are not ideal for providing broadband to trains. The reasons for using a spectrum in the high frequencies are multiple. Some of the reasons are listed here.
The railway corridor tends to be straight, which means that directional antennas can be used, both on the train and on the trackside equipment (GSM-R antennas typically have a 30° beamwidth). In general, the dimensions of highly directional antennas scale with wavelength, and so these are much more practical for higher frequencies. For a given antenna size and weight, a more directional antenna can be made for higher than for lower frequencies. This will have a higher boresight gain, which will compensate somewhat for the poorer propagation of higher frequencies. But there is a limit on how narrow a beam can be whilst still maintaining a reliable connection to what is, after all, a moving train which may turn away from the antenna boresight as the track curves. It is thought this limit is around 20-30°, depending on the specific topology of the track. Once the beam width reduces to this value, there is no great advantage in using higher frequencies. Small antennas can be manufactured with this beamwidth for frequencies of around 3 GHz.
Better MIMO performance may be provided at 2600 MHz, since electrical spacing between antennas is higher at higher frequencies and train antennas are vertically polarised, so no X-polar discrimination may be present.
2600 MHz may provide spectrum that is less widely used geographically (e.g., the spectrum is only used in a limited or small number of sub-areas within a geographical area such as a city, a region or a country), so lower co-channel interference.
The poorer propagation characteristics of higher frequencies are more significant for non-line-of-sight (NLOS) propagation conditions, where frequency exponents as high as 30 dB/decade can be experienced. If LOS propagation conditions can be maintained, then the frequency exponent is limited to 20 dB/decade. Furthermore, the range over which LOS communications can be maintained actually increases with frequency, due to the narrower Fresnel zone. This can be seen if we consider the geometry of the train backhaul scenario as shown in FIG. 4.

The propagation starts to become NLOS once the Fresnel zone is penetrated by an object. In the train backhaul scenario, this object could be a bridge, the local terrain (if the track is curved), or even the ground.

It has been found that for typical mast heights of 15-20 metres, LOS propagation could be maintained to a train for frequencies above 2600 MHz even with a mast spacing as high as 5 km. Of course, it is unlikely that the Fresnel zone will be completely clear over this sort of distance, particularly on electrified lines or lines in urban areas, but the potential of higher frequencies for this type of scenario is clear.

Both higher and lower frequencies offer advantages. Lower frequencies offer generally better propagation characteristics, but higher frequencies offer more directional antennas, more bandwidth and the prospect of LOS propagation over longer distances. Based on the above considerations, a preferred would be that of around 3 GHz. SO, both the 2.6 GHz band (bands 7 and 38) and the 3.5 GHz band (bands 22, 42 and 43) are preferred candidates for the spectrum selection.

The following link budget comparisons show the advantage of using 800 MHz over 2600 MHz. In particular, directional antennas can be used at both ends of the link, higher transmit power can be used on the uplink (37 dBm vs 23 dBm) and the terminal noise figure may be lower for 2600 MHz compared to 800 MHz.

| | | | | Advantage of |
|---|---|---|---|---|
| | 800 | 2600 | | 800 over 2600 |
| | MHz | MHz | Units | MHz (dB) |
| Downlink | | | | |
| Transmit Power | 61 | 61 | dBm/ | 0 |
| | | | 5 MHz | |
| | | | EIRP | |
| Transmit Antenna | 14.4 | 17.7 | dBi | 0 |
| Gain | | | | |
| Pathloss | Variable | Variable | dB | 15 |
| Receive Antenna | 5 | 9.5 | dBi | −4.5 |
| Gain | | | | |
| REFSENS | −97 | TDD: −100 | dBm/ | TDD: −3 |
| | | FDD: −98 | 5 MHz | FDD: −1 |
| Net Advantage | | | | TDD: 7.5 dB |
| | | | | FDD: 9.5 dB |
| Uplink | | | | |
| Transmit Power | 20 | 31 | dBm/ | −11 |
| | | | 5 MHz | |
| | | | TRP | |
| Transmit Antenna | 5 | 9.5 | dBi | −4.5 |
| Pathloss | Variable | Variable | dB | 15 |
| Receive Antenna | 14.4 | 17.7 | dBi | −3.3 |
| REFSENS | −101.5 | −101.5 | dBm/ | 0 |
| | | | 5 MHz | |
| Net Advantage | | | | −3.8 dB |

It can be seen that LTE 800 has a net 7.5 dB link budget advantage over TD-LTE 2600 in the downlink (9.5 dB over FDD LTE 2600), but LTE 2600 has a net 3.8 dB advantage in the uplink. Note that powers have been normalised to a 5 MHz bandwidth, so no penalty applies to using the full bandwidth of the band. It should be noted that the uplink transmit power limit for LTE 800 is independent of the bandwidth of the channel, and thus the calculations would have to be adjusted if a bandwidth other than 10 MHz was assumed.

For TDD, the above link budgets still apply, though the duty cycle would have to be taken into account when computing the throughput.

### Architecture

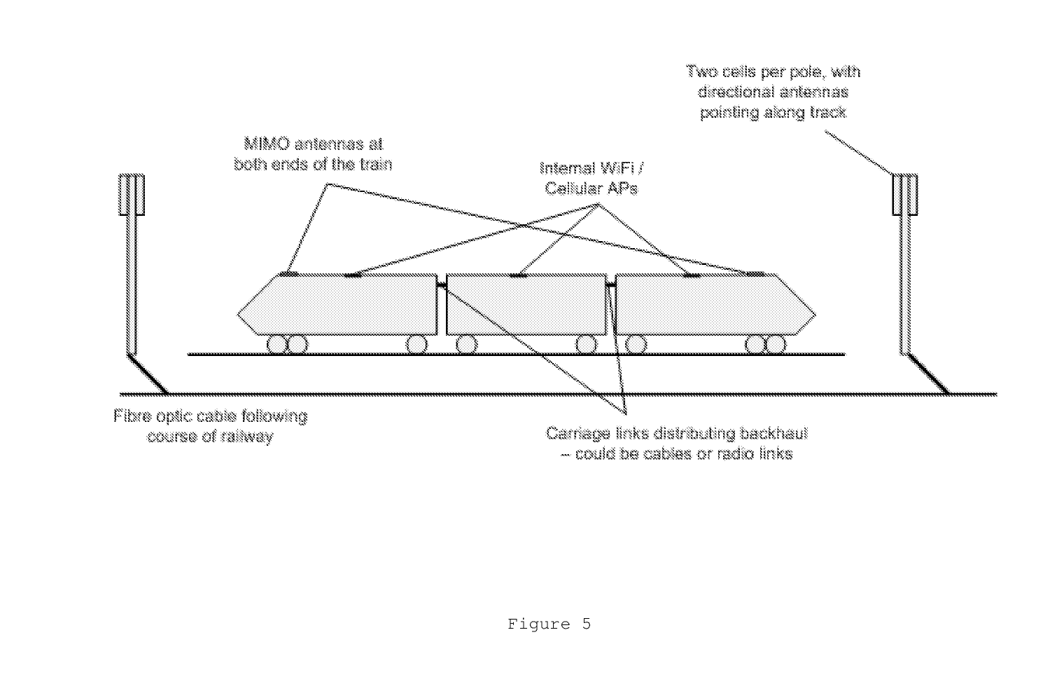

Dedicated architectures can only use one set of antennas on the train. This is especially true for trains that are small relative the cell size, and hence the best serving cell will be independent of the location of the antennas on the train. The proposed architecture uses two or more separate antennas and modems, located at either end of the train, to connect two cells simultaneously. The use of two or more separate antennas and modems has been found to be feasible because, as the cell size reduces using dedicated trackside infrastructure, a train of a certain length (for example, inter-city trains can be around 250 m in length) is not anymore of a small size relative to the cell size. Hence a portion of the train (e.g., the front part) may be covered by a first cell, while a second portion of the train (e.g., the rear part) may be covered by a second cell. Similarly, three or more portions of the train could be each covered by a separate cell, and therefore a separate antenna and/or modem can be provided to each portion. Additionally, if it is desired to use directional antennas on the train, the proposed architecture provides a greater advantageous technical advantage as one set of antennas may point forward of the train, and the other to the rear. Thus, an improved architecture is achieved, one example of which is shown in FIG. 5. The modems could be combined in a centralised modem—for example, a modem which has multiple ports, each connected to a separate antenna. Other similar solutions can also be deployed (e.g., CoMP architecture).

In the next sections, details of the proposed architecture are examined in more detail.

### Trackside Antennas

The trackside antennas may conform to the usual requirements of the weight and wind loading that can be supported by the mast itself, and the need to be X-polar (to maintain isolation between the MIMO streams). Standard cellular panel antennas could be used in this architecture, though these typically have a wider beamwidth than 30° (the preferred beamwidth br linear rail coverage scenarios). For example, the choice of 30° beamwidth antennas is preferred for 6-sector macrosites. In addition, if it is desired to support other services from the same antennas (such as GSM-R or LTE 800) then a suitable multi-band antenna with the correct beamwidth for these applications could be provided.

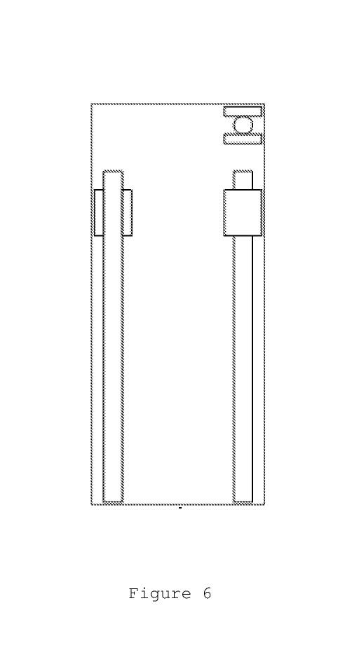

A problem could arise with mounting of additional antennas for MIMO applications. For 2×2 MIMO (as shown in FIG. 6), this is straightforward as a typical antenna mounting configuration could be similar to that used for GSM-R, where one sector points up line and the other down line. This is because X-polar antennas will support both MIMO streams from a single unit.

For 4×4 MIMO, however, the situation is more complicated because the antenna required to support the additional two MIMO streams must be spatially separated from the original two, as antennas can only support a maximum of two orthogonal polarisations. A heuristic rule for relatively uncluttered propagation environments is that the antennas must be separated by around 10 wavelengths, which corresponds to 1.15 m at 2.6 GHz but a somewhat impractical 3.75 m at 800 MHz (this is another advantage for using higher frequencies—e.g., 2.6 GHz—over lower frequencies—e.g., 800 MHz—for the proposed architecture).

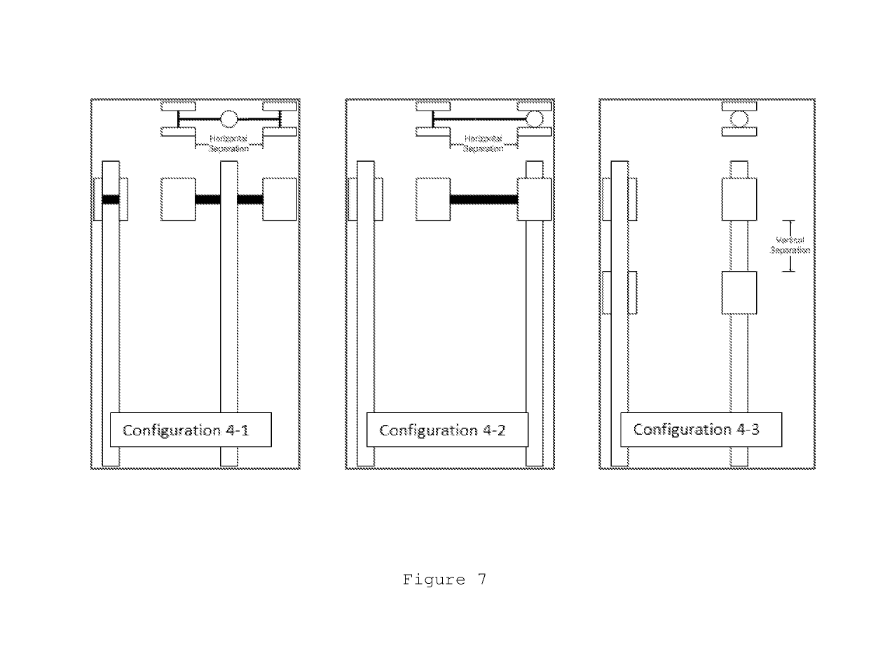

Some possible configurations for a two sector 4×4 MIMO site are shown in FIG. 7.

Configuration 4-1 is preferred, as this will give the best 4×4 MIMO performance whilst minimising the wind loading on the mast compared to other configurations that give the same performance, such as Configuration 4-2. Configuration 4-2 is proposed for situations where the mast is located such that extending the antenna mounting beam towards the track would breach the loading gauge for the route. However, this configuration also increased significantly the wind loading on the mast due to the torsional forces that are generated. The minimum wind loading configuration is that shown by Configuration 4-3 where vertical antenna separation is used, but this also has a lower MIMO performance that the other configurations due to the higher pathloss that will be experienced by the lower antenna. Configuration 4-3 may be advantageously used for its lower site engineering costs.

External on-Train Antennas There are more specific requirements on antennas mounted on the train itself, as these must meet minimum standards for safety and robustness (to factors such as the weather and the more general railway operating environment). In Europe, the antennas must meet the EN 50155 railway standard, issued by CENELEC. For example, a wideband omni-directional antenna could be used. Similarly, a narrowband directional antenna could be used

The antennas may be vertically, and thus singularly, polarised. Hence four are required to support 4×4 MIMO scenarios. Even in the event that only 2×2 MIMO is being used, the use of four antennas on the train is recommended due to the increased receive diversity benefit that these will provide in low SINR situations.

The antennas need to be spatially separated, and the recommended configuration is a square pattern with each side being around 10λ in length (i.e. 1.15 m at 2.6 GHz). A MIMO adapter plate can be used to enforce a limited amount of spacing between two antennas, but the main advantage of this is the reduced number of holes that need to be drilled in the train roof. In addition to spatial separation, tilting two of the antennas by +45° and the other two by −45° would provide some additional polarisation diversity, though this may not be practical due to antenna mounting considerations.

A digital Distributed Antenna Schemes (DAS) is another alternative for 800 MHz tunnel coverage. The RF signal from a donor base station is digitised and transferred to a distant RF head, either by fibre or by microwave link, where the signal is regenerated and retransmitted to provide localised coverage. All RF signals in a DAS can be logically from the same cell removing the need for handovers between the RF heads.

### Optic Fibre Network Requirements

It is generally assumed that the fibre optic network along the railway line can be used for interconnecting the radio sites deployed along the track side and subsequently to an NNI (Network to Network Interface) point(s) where the traffic will be handoff to the operator.

An operator using the other party's fibre along the rail could have two service options, namely dark fibre and managed fibre.

In the case of dark fibre, daisy-chained fibre between the sites along the track may be used, and some fibre techniques such as WDM (Wavelength Division Multiplexing) may be used to minimise the fibre consumption, and impact of loss of power to a mast site.

In the case of a managed service, the service parameters should be taken into account, though connecting the handover locations should be possible.

One possible fibre optic network is a WDM optical network with an MPLS core which could provide connectivity (i.e. resilient wavelengths) to each GSM-R site. From the MPLS backbone there will be NNI points to handoff the managed service to an operator.

### Summary of Some of the Improvements

There are at least three elements to the improved train backhaul solution:
1. The use of LTE technology for high throughput and cost effective equipment. Furthermore, the use of TD-LTE technology offers the additional advantages that:
   The resource split between uplink and downlink can be controlled
   Capacity from this band can be dedicated to the train backhaul service, as it will not be used provide a more general wide-area service
   As this band will not be widely used, it should be relatively free from interference
2. The use of 2.6 GHz spectrum for high available bandwidth, practical directional antennas, reasonable antenna separations for 4×4 MIMO support and licensed spectrum for a controlled interference environment
3. Directional antennas at both ends of the train to improve the link budget and allow simultaneous connection to two separate cells

Such a solution is investigated in the later section on case studies.

### On-Board Access Points

Apart from the repeater solution, there are two main possibilities to provide broadband service on board:
Wi-Fi-Access points corresponding to the 802.11 standard
3G or LTE femtocells

### Repeaters

Repeaters are wideband amplifiers installed on board of the train to overcome the high carrier attenuation. They receive, amplify, and retransmit the signal entering and leaving the train and use GPS positioning to set the correct repeater parameters. All common mobile communication standards are supported (e.g., GSM, EDGE, DCS, CDMA, WCDMA, and LTE operating in any band). Adaptable gain equalizes the influence of near and far base stations. It is a very simple and cheap solution since all mobile providers can be covered by this equipment. Inside the coach leaky feeder cable can be used to distribute the signal.

But repeaters also have certain drawbacks: Firstly, noise and interference is a significant issue, which is addressed in all solutions by adaptable repeater gain. Furthermore there is no possibility to separate on-board and backhaul access technology and repeaters do not provide the advantage of grouping users and so reducing the number of handovers that has to be carried out at the same time, when the train crosses cell boundaries.

### In-Train Propagation

For Wi-Fi, inside the coach a waveguide effect is observed and propagation loss is less than in free space, whereas in the inter-coach communication doors and re-entering waves augment the attenuation. In the operating frequencies of current 3GPP mobile communication standards, a propagation model with—depending on the frequency—slightly lower or higher path loss than free space, respectively, is observed. Based on the above, and on other considerations, one access point per carriage is used in the proposed solution both for Wi-Fi and Femto.

There is only an estimated value for the carriage attenuation, around 45 dB for UMTS.

### Wi-Fi Access Points

Carrier grade Wi-Fi Access points supporting IEEE 802.11n and IEEE 802.11 ac are able to reach data rates of 600 Mbit/s and more. Modern smartphones support WiFi data rates up to 150 Mbps. Most applications and services don't need such data rates, and hence the bottleneck will be the backhaul link to the train. Wi-Fi equipment can support several network identities (SSIDs) and could for instance offer a train operator specific Wi-Fi network (authenticated using a landing page) and one specific for a mobile operator (i.e. authenticated automatically without username/password using the SIM credentials—e.g. EAP-SIM).

In the literature, interference is often not seen as a problem, due to the additional attenuation of the coach structure and the interference avoidance implemented in the standard (CSMA/CA). Nevertheless, it operates in the unlicensed band, so there are a large number of potential interferers, which can lead to serious performance degradation. In addition, so called registration storms can occur when a high number of users try to register automatically to a WiFi network, e.g. when the train arrives in the station.

Furthermore to implement only WiFi on board is not sufficient to overcome the low quality of service concerning voice calls in trains. There are over-the-top voice applications which could use Wi-Fi.

### LTE/UMTS-Femtocell

In this section we use femto cell as synonymous for a cellular small cell. Different architectures are possible, including using macro BTS equipment with different sectors/end points on the train.

One clear advantage of the femtocell solution is that it could provide both, voice and data traffic, at high quality. Furthermore passengers could be separated regarding their service providers and therefore treated individually. Femtocells provide service in a range between 10 and 40 m, so it is basically the same situation as for WiFi. The difference here is that femtocells are operating in the licensed spectrum.

There is a potential interference issue between femto cells and macro cells if they operate in the same spectrum. Some have suggested advanced algorithms to handle this. Algorithms for dynamic resource allocation of moving femtocells are presented in “Resource Allocation in Cellular Networks Employing Mobile Femtocells with Deterministic Mobility”, Sobia Jangsher and Victor O. K. Li, Department of Electrical and Electronic Engineering, University of Hong Kong, 2013 IEEE Wireless Communications and Networking Conference and in “Seamless Wireless Connectivity for Multimedia Services in High Speed Trains”, Ouldooz Baghban Karimi, Jiangchuan Liu, and Chonggang Wang, IEEE JOURNAL ON SELECTED AREAS IN COMMUNICATIONS, VOL. 30, NO. 4, MAY 2012 (in the second indirect via the handover topic), but both assume that the movement of the train is deterministic and can be used to compute its future positions, which somehow is correct, but perhaps not a practical consideration. Another possibility would be dedicated resources for the on-board femtocells, which is not efficient. So interference, frequency reuse and hence the amount of available bandwidth per femtocell are the major issues of this solution. Femtocells should provide at least the same data rate like the backhaul network, which would require per train up to twice the available backhaul bandwidth.

As discussed above, inside the coach a waveguide effect is observed and propagation loss is less than in free space, whereas in the inter-coach communication doors and re-entering waves augment the attenuation.

Due to the high speed of trains, small cell handovers become much more frequent. They cause a massive overhead in signalling information, so this solution will avoid unnecessary handovers entering and leaving the femtocell. 3GPP-LTE standard provides the idea of self-organizing networks to improve network performance via auto-adaption of network parameters. An algorithm, which adapts handover parameters, such as hysteresis and time-to-trigger, could be used. Another possibility to avoid undesired handover into the cell is to restrict the initial access, e.g. via a delay or mobility information. The latter can be obtained as defined in the 3GPP standard by counting handover or cell reselection. Other possibilities to obtain the mobility information are the train system or external sensors. In a similar way, handover out of the femtocells could be addressed. A good femto-coverage in the train, one logical train-cell or setting up a user history are other methods to avoid UE switching back to the macrocell. Furthermore, the additional concept of “in-train hand over” should be preferred, when the UE moves through the train.

At the moment 3G femtocells are able to support up to 16 active users, so they can only be seen as an amendment to WiFi or LTE femtocells, e.g. for voice. LTE femtocells are being developed at the moment; at least their first versions will happen to have a maximal number of supported users, which should be kept in mind.

Further problems to be addressed for the femtocell solution are PCI confusion, the integration of multiple operators, and the reconfiguration of cells crossing national/regulatory borders.

Handling/management of moving Femtocells may further involve dealing with the following:
PCI confusion
   Limited Physical Cell Identifier (504)
      Same PCI for all train
      Same exclusive PCI for all trains (Allows easy identification as moving cell)
      Random PCI
      Random PCI from determined set
      Random PCI from determined exclusive set (Allows easy identification as moving cell)
Neighbouring Lists
   Dynamic via sensing/GPS
   Static
      All “train cells”/“moving cells” are neighbours of all cells
      All “train cells”/“moving cells” are neighbours of possible access point (e.g. station cells)
Application of special System Parameters
   Unique identification of moving femtocells allows to apply special system parameters (e.g. for handover, paging)
   Either as mentioned above or with a mobile femtocell list/mobility status for cells

### Inter-Coach Communication

The connection between coaches can be realised by cable or wireless. The former is simple but may not be feasible due to railway requirements. In this case the inter-coach communication had to be realised by either WiFi or LTE connection. A wired connection may provide a set of advantages, such higher transmission quality and no need for additional spectrum. Likewise, the disadvantages may include: if the cable has to be refitted, it may cause difficulties at the mechanically critical connection point between carriages and even inside a carriage.

Possible inter-carriage communication technologies may include:

(1) using an on-train bus;

(2) running additional signal over the existing cables;

(3) connect carriages wirelessly; and

(4) place a shore-to-train unit in every carriage.

Option (1) appears to be most straightforward, but there are some constraints: the capacity may not be sufficient, the bus may not be accessible from the position of the train-to-shore device, and there may be the need for additional couplers. If available, this option is assessed to be the most favourable. A standard for on-train communication may be taken into account for systems in future train models.

As an example of option (2), power line communication (PLC) may not be feasible in the highly noisy and safety critical railway environment.

The wireless connection may not require any change to the physical carriage connection, but there may be the need for additional equipment inside the carriage if the passenger access point does not support wireless backhauling. Option (4) may serve to work around the inter-car-connection problem.

### Initial Concept Verification Architecture

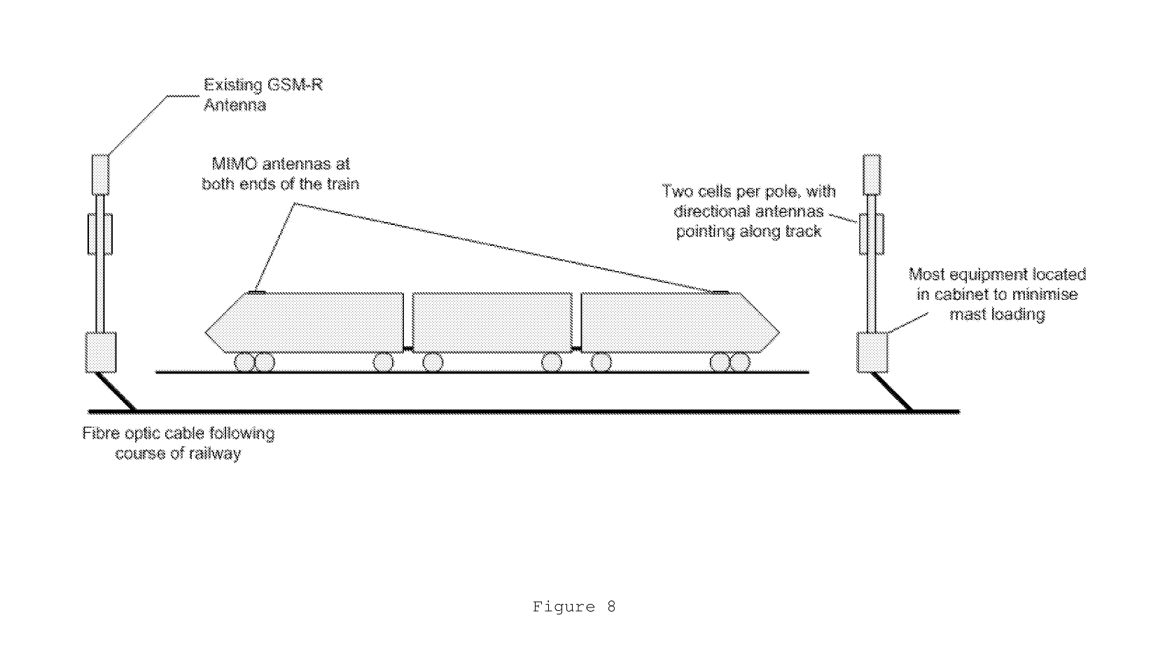

The proposed architecture for a cabinet based solution for the train backhaul is shown in FIG. 8. The motivation behind this architecture is to:
Avoid any impact on the existing GSM-R antennas
Minimise equipment installed at height on the mast to minimise weight and wind loading
Increase maintainability by making access to the equipment straightforward without the need to work at height
Minimise the requirements for external resource required per mast to:
   Power (230 V AC single phase proposed)
   Fibre optic cable (CPRI capable)
      However, where the track passes through a tunnel, a slight modification may be made. There only a single additional sector may be installed on the main sites, pointing north and south respectively, away from the tunnel. A separate antenna may be installed at the repeater sites for tunnel coverage. These antennas may be connected to a local RRH (Remote Radio Head), which may then be connected back to the BBU (Base Band Unit) located in the cabinet at the main site.

### Technology and Spectrum Band

TD-LTE technology using 20 MHz of Band 38 spectrum (2575-2595 MHz) may be used. A mobile technology is used to provide the backhaul link, since the train is moving, and thus must handover between sectors. Two spectrum bands may be used. In the 2600 MHz band, either TDD LTE in Band 38 spectrum (2575-2595 MHz) or FDD LTE in Band 7 (2500-2520 MHz Uplink; 2620-2640 MHz Downlink) or both, depending on the availability of a suitable on-train modem may be used. In the 800 MHz band, FDD LTE in Band 20 (801-811 MHz Downlink; 842-852 MHz Uplink) may be used.

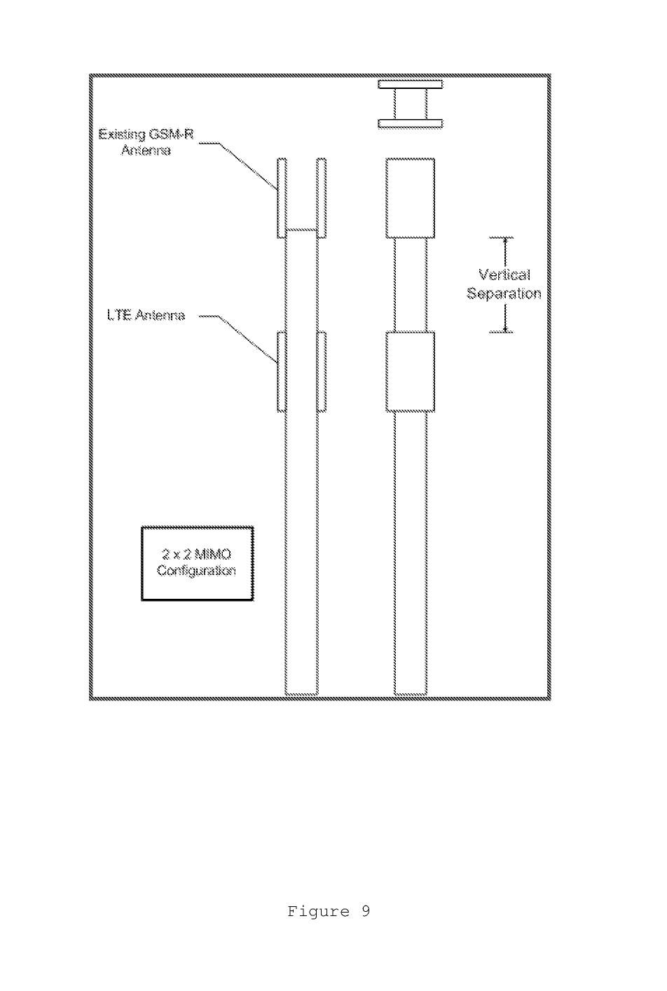

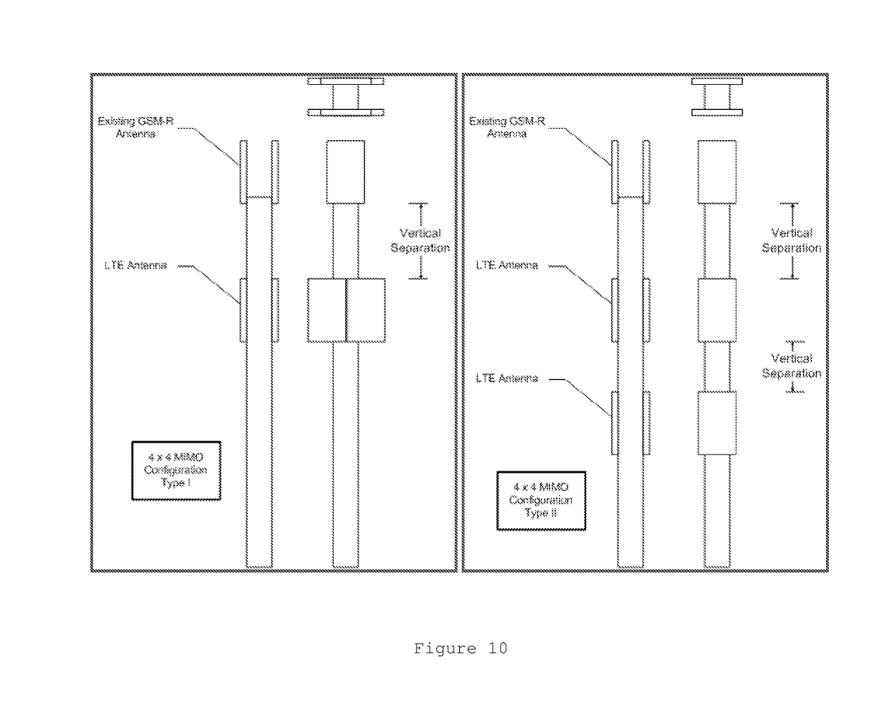

Mast Antennas It is proposed not to use or modify the existing GSM-R antennas, which are typically mounted at the top of the masts. Hence the new antennas must be mounted below these. Three antenna configurations are being considered—one of which supports 2×2 MIMO (shown in FIG. 9) and two of which support 4×4 MIMO (shown in FIG. 10). The configuration may depend upon the weight and wind loading limits for a mast.

Note that the Type I 4×4 MIMO has no significant spatial separation between the two LTE antennas. Hence the MIMO performance will be limited. The Type II 4×4 MIMO configuration should be better than Type I on tall masts, but worse for low masts. A mix of Type I and II deployments can be used. A vertical separation between antennas of around 1 metre is proposed.

For repeater masts at either end of a tunnel, it is proposed to use a X-polar Yagi antenna due to space restrictions.

### On-Train Equipment

This section discusses the on-train architecture for the train mobile broadband backhaul project.

### Possible Architecture

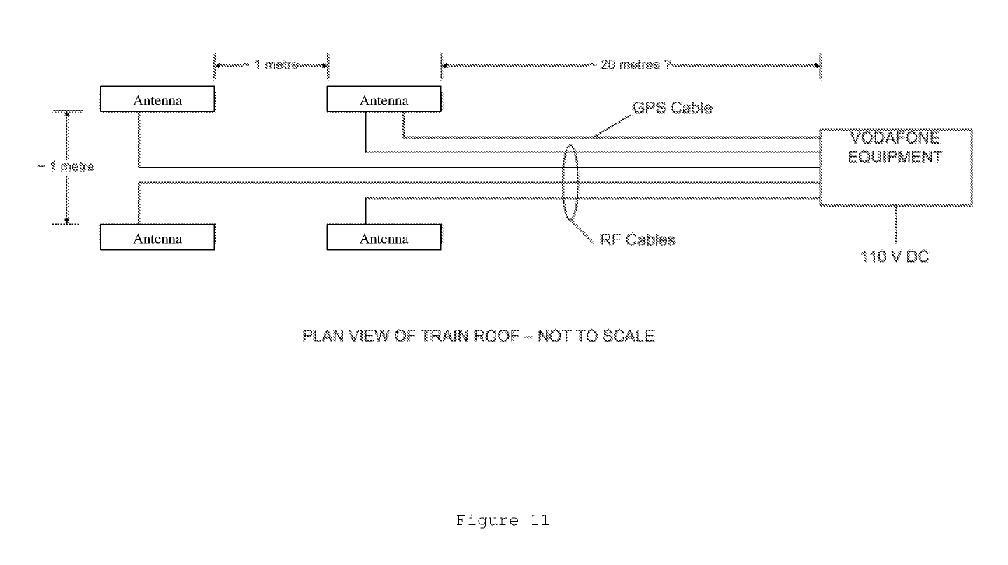

A possible on-train architecture is show diagrammatically in FIG. 11, where the view is from above the train looking down onto the roof. It is proposed that this architecture is repeated at both ends of the train.

A 4×4 MIMO can be used, and therefore require 4 separate antennas to be connected to the modem equipment. If the antennas are vertically polarised, they require to be spatially separated, and it is propose d to mount these in a square pattern with approximately 1 metre separation between antennas.

The RF cables are then run along within the roof space of the train to the equipment rack, along with a single GPS cable.

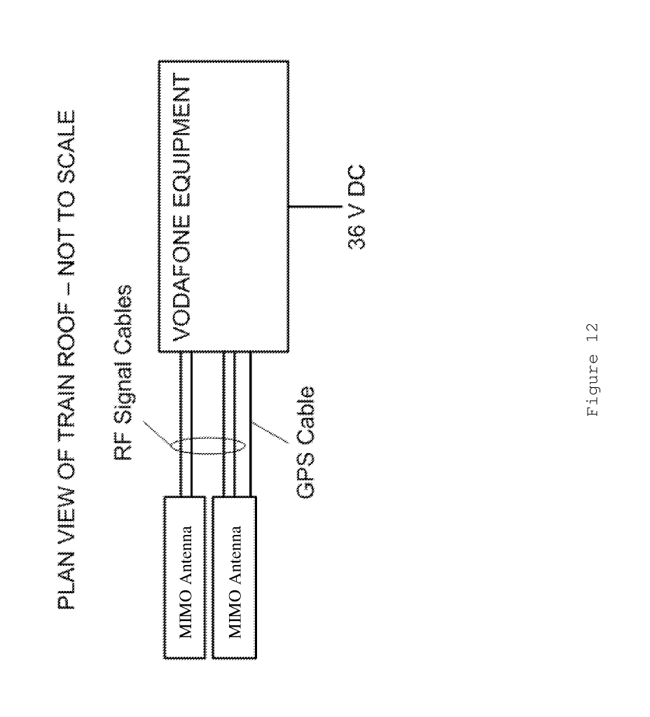

In an alternative 4×4 MIMO architecture, a pair of MIMO antennas could be used instead of the four antennas of FIG. 11—the pair would give a total of 4 antennas (see FIG. 12).

### Cabinet Based Trackside Equipment

The following equipment options exist: rack mounted RF modules; external RF modules.

Two types of active transmission equipment are used at each site: a baseband unit (BBU) which does the baseband processing; and an RF module, which modulates the specified frequency band using the baseband signals. The RF module may be located either inside or outside the cabinet, depending on the model. The two units may be connected by an optical fibre (CPRI) interface. More than one of each type of unit is typically required at each site. The cabinet should be located as close to the mast as possible, so as to minimise cable runs to the antennas and any RRH equipment.

Although designed to be mounted at the top of a mast, the RF modules can be mounted at the bottom of each mast due to wind loading and weight requirements.

### EPC

Two options can be considered for the EPC:
Connection to a live core operated by an MNO
A dedicated EPC for the train backhaul system

### Preferred Embodiments

Preferred, further embodiments are described in the following paragraphs. Any of the elements described below could be combined and/or otherwise added/substituted to elements as described above.

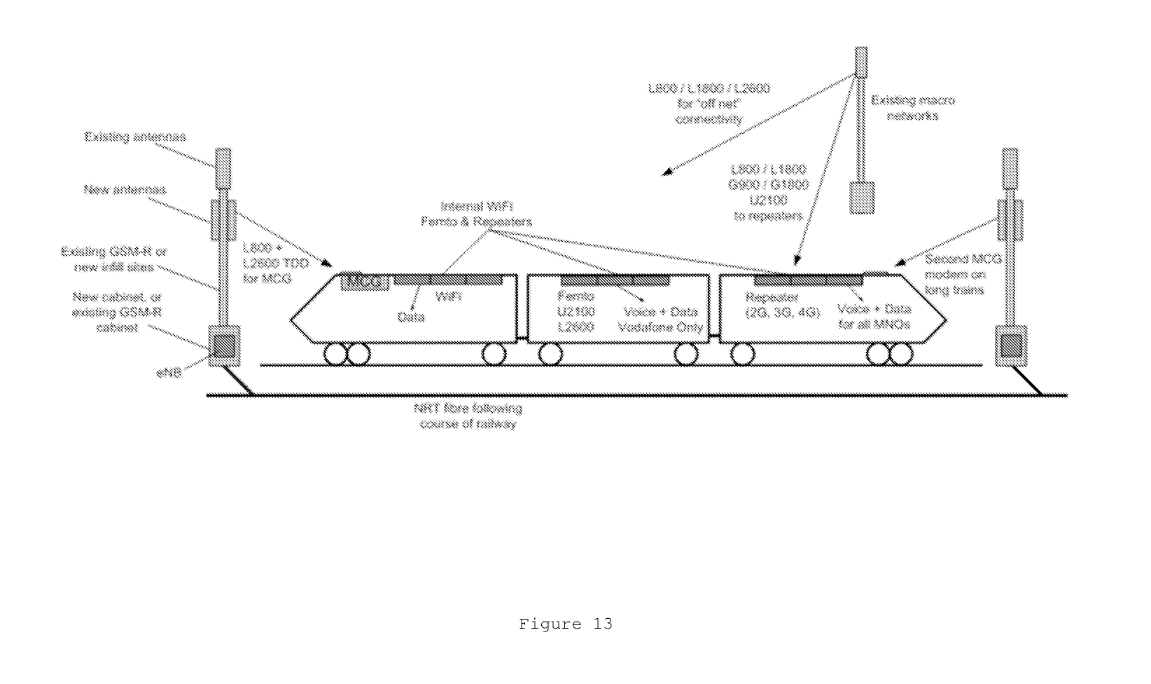

In particular, FIG. 13 shows a further embodiment of architecture for providing broadband services to train.

In particular, 4G LTE technology is deployed trackside to provide connectivity and bandwidth to a Mobile Communication Gateway (MCG) installed on the train. Two frequency bands will be deployed to existing GSM-R trackside sites, 800 MHz FDD (employing 2×2 MIMO) and 2600 MHz TDD (employing 2×2 MIMO with 4-way receive diversity) to maximise performance and bandwidth towards the train MCG. Two modems may be fitted to each train, one at each end of the train.

Each trackside site has two sectors, orientated to point in opposite directions along the track, with both sectors logically configured as a single cell. One advantage of this configuration is that it minimises any issues associated with rapidly varying signal levels and high speed handovers as trains pass close to the sites. It also minimises the amount of hardware required track side. Passengers on the trains are served by Wi-Fi access points, internal to the carriages of the trains, linked to the MCG, which backhaul the traffic to a core network belonging to a network operator. For Wi-Fi access, either EAP-SIM will be supported (for cellular customers) or passengers will access via a suitable landing page.

Voice and cellular data services are supported by on-train repeaters that enhance the coverage of macro sites covering the tracks. In addition, cellular voice and data services are offered by on-train femtocells that can radiate both 3G (e.g., UMTS2100) and 4G (e.g., LTE2600) signals inside the carriages. The purpose of the inclusion of femtocells on trains is to provide continuous voice and cellular data coverage, including not spots such as tunnels, without the need for additional trackside infrastructure. The MCG to trackside 4G link provides the backhaul for the femtocell traffic.

For trackside, the following equipment components may be considered:
Antennas: Two 6-port antennas mounted as high as is practical on the GSM-R mast. Each antenna has two low band ports for the 800 MHz signals to support 2×2 MIMO and four high band ports for the 2600 MHz signals. 2×2 MIMO with 4-way receive diversity may be used for 2600 MHz to maximise performance and minimise the amount of trackside hardware. Two antennas may be deployed on each GSM-R mast with each sector orientated to point in opposite directions along the track. The two sectors will be configured as a single logical cell to minimise any handover issues associated with rapidly varying signal levels as high speed trains pass close by to the sites.
Remote Radio Units (RRU): These are designed to operate in an external environment and are mounted external to any cabinets. Two RRUs may be used per site, one for the 800 MHz band and another for the 2600 MHz band. Each RRU has a power splitter to distribute its signals to both sectors of a trackside site.
Base Band Unit (BBU): The BBU is mounted internally in a secure, weatherproof enclosure (either the existing GSM-R enclosure or an additional dedicated trackside enclosure). Power for the BBU can be either −48V d.c. or 230V a.c. The BBU provides optical fibre feeds to the RRUs. Alternatively, the BBU can be located outdoors. Normal practice is to then install the BBU with the RRUs, caged, if necessary.
Cell Site Gateway (CSG): This unit terminates the Network Rail optical transmission link and distributes the transmission within the BBU. The CSG is mounted internally in a secure, weatherproof enclosure (either the existing GSM-R enclosure or an additional dedicated trackside enclosure). Power for the CSG can be either −48V d.c. or 230V a.c.

In the scenario that 3G trackside equipment is required to improve UMTS2100 voice coverage, the following additional equipment is used.
Antennas: The 3G transmissions will share the same antennas as those used for 4G so no additional antennas are necessary.
Remote Radio Units (RRU): An additional RRU is required to cover the 2100 MHz frequency band, which will be mounted with the 800 MHz/2600 MHz RRUs.
Digital Unit (DU): An additional DU is required in the BBU.

In particular, to support voice and data services, the following equipment will be installed on the trains.
MCG (Mobile Communications Gateway): to provide connectivity from the trains to the trackside infrastructure and backhaul for traffic generated by on train WiFi Access Points and femtocells. (e.g., one or two per train)
WiFi Access Point: to enables customers to receive WiFi data services, which will be available to all passengers (subject to suitable commercial agreements). The WiFi traffic will be backhauled over the MCG to trackside 4G link with connection via an internal LAN on the train. (e.g., one per carriage.)
Repeaters: all cellular customers will be able to access cellular data and voice services via on train repeaters that will enhance their existing cellular operator's external macro network signals (quantity dependent on train specifics). Each repeater will be capable of covering the following spectrum/technology bands:
   LTE800
   GSM900
   GSM/LTE1800
   UMTS2100

Filtering in the repeaters will selectively enhance specific spectrum bands.
Femtocells: some customers may be able to access 3G and 4G cellular data and voice services via femtocells connected to the MCG. The femtocell traffic will be backhauled over the MCG to trackside 4G link with connection via an internal LAN on the train. (e.g., one per carriage.)

Generally, the MCG will receive coverage from the trackside masts. In situations where “off railway” masts are located close to the railway routes and distant to the “on-railway” (trackside) mast that would otherwise serve the train, there may need to be exceptions to manage the mutual interference between the transmitters. In addition, interference scenarios may apply to the 800 MHz spectrum band when an “off train” customer close to a trackside site, attempting to communicate to a distant “off railway” site would suffer unacceptable interference without access to the best server. For 800 MHz an end to end Quality of Service (QoS) can be implemented so that traffic from the MCGs is prioritised over other user's traffic on trackside sites.

In order to provide high quality voice services, a preferred embodiment requires the installation of an MCG, femtocells and RF repeaters on the train. The advantage of this solution is that it supports any voice services, including from multiple network operators and/or premium services, without the need to install additional trackside equipment other than that required to support 4G backhaul of the MCG, using only the licensed spectrum of one network operator.

To aggregate the capacity of multiple links or networks, the MCG should support “load balancing” or “channel bonding”, whereby the MCG itself will decide over which route a particular IP stream should be sent. If carrier aggregation at the physical layer is implemented (e.g. between L800 and L2600 TDD), then this would be viewed as a single route by the MCG, but otherwise the MCG would decide which carrier to use according to a set of defined rules. Some implementations of channel bonding allow the uplink and downlink traffic to be sent over different routes, and this is seen as being beneficial for delay tolerant traffic.

The MCG should support GPS, so that it is location aware. This will allow a number of location aware services, including emergency call location, to be implemented.

On-train voice services will primarily be supported through the use of on-train RF repeaters without additional trackside equipment. Repeater systems are modular, and will be capable of supporting 2G, 3G and 4G voice services. This solution allows voice services to continue uninterrupted when the train moves “off net”.

Experience with RF repeaters has shown that dropped calls may still be experienced, particularly in tunnels. Consequently, the solution proposes to install 3G/4G femtocells on trains to further support voice services. These would offer a continuous voice service through tunnels and other current not-spots. Other rail passengers may be able to use VoIP applications via the on train Wi-Fi to make voice calls in these not-spots.

In addition, the solution proposes to use a distributed femtocell architecture, whereby a small RF unit (pico RRU) is installed in each carriage, and connected via a cable (e.g, Cat 5e cable) to a hub and then back to a common baseband unit (BBU). The BBU would then be backhauled via the MCG and trackside infrastructure directly to a network operator RAN using Iub over IP. The advantage of this architecture is that the femtocells will be managed as an integral part of the network operator's network, simplifying O&M and allowing scenarios such as handover between carriages (as a passenger walks along the train) and between platform and train to be supported. The pico RRU may be combined with the WiFi access point, thus reducing installation costs.

The quality and service continuity of the on-train voice service provided by on-train femtocells is directly related to the minimum data throughput levels that can be provided to the train from the trackside infrastructure. The required data rates are low compared to the overall backhaul capacity. As voice is a delay sensitive service, the MCG may be required to prioritise voice traffic over general internet traffic in order to maintain quality to an acceptable level.

1. A cellular radio network system for communicating with at least one vehicle-based mobile gateway terminal, the at least one mobile gateway terminal being configured to communicate a network service for one or more user mobile terminals on-board the vehicle, the system comprising:
a plurality of network cells, configured to provide cellular radio network coverage along a route of the vehicle, each network cell being dedicated for communication with the at least one vehicle-based mobile gateway terminal so as to allow communication between the at least one vehicle-based mobile gateway terminal and a core network of the cellular radio network.

2. The cellular radio network system of claim 1, wherein the vehicle route is predetermined and the plurality of network cells are located along the predetermined route.

3. The cellular radio network system of claim 2, wherein a spatial separation between at least one of the plurality of network cells and the predetermined route is based on one or more of: the height of an antenna of the cell; a height of the vehicle; a maximum, minimum or average distance between the vehicle and the antenna; and the frequency of communication.

4. The cellular radio network system of claim 1, wherein the vehicle is a train.

5. The cellular radio network system of claim 1, wherein each network cell is configured to allow the network service for the one or more user mobile terminals on-board the vehicle to be one or more of: a circuit-switched cellular radio network service; a packet-switched cellular radio network service; and a packet-switched non-cellular radio network service.

6. The cellular radio network system of claim 1, wherein each of the plurality of network cells has at least one respective antenna, the at least one antenna of a first of the plurality of network cells being co-located with the at least one antenna of a second of the plurality of network cells.

7. The cellular radio network system of claim 1, wherein each of the plurality of network cells has a respective MIMO antenna structure.

8. The cellular radio network system of claim 1, wherein each of the plurality of network cells has a respective directional antenna structure.

9. The cellular radio network system of claim 8, wherein each directional antenna structure has a beam width not greater than 30°, 33°, 35°, 40°, 50° or 60°.

10. The cellular radio network system of claim 1, wherein each network cell is configured for communication with the at least one vehicle-based mobile gateway terminal using a Long Term Evolution architecture.

11. The cellular radio network system of claim 1, wherein each network cell is configured to allow communication between a network cell onboard the vehicle that is in communication with the at least one vehicle-based mobile gateway terminal and a core network of the cellular radio network using an Iub over IP protocol.

12. The cellular radio network system of claim 1, wherein the at least one mobile gateway terminal is configured to act or be in communication with another device that is configured to act, in order to provide the cellular radio network service to one or more user mobile terminals on-board the vehicle, as one or more of: a cellular radio network repeater; a local access point for the cellular radio network; a gateway to a Local Area Network; and a network cell.

13. The cellular radio network system of claim 1, further comprising the at least one mobile gateway terminal.

14. A method for communicating with at least one vehicle-based mobile gateway terminal, so as to allow the at least one mobile gateway terminal to provide a cellular radio network service to one or more user mobile terminals onboard the vehicle, the method comprising:
providing cellular radio network coverage along a route of the vehicle using a plurality of network cells, each network cell being dedicated for communication with the at least one vehicle-based mobile gateway terminal;
configuring the plurality of network cells to allow communication between the at least one vehicle-based mobile gateway terminal and a core network of the cellular radio network.
